(19) United States
(12) Patent Application Publication
(10) Pub. No.: US 2011/0041379 A1
(43) Pub. Date: Feb. 24, 2011

(54) Bait rigging holder

(76) Inventors: Doug Salomon, Roanoke, VA (US); Jefferson D. Whitehead, JR., Southern Pines, NC (US)

Correspondence Address: WELSH FLAXMAN & GITLER LLC, 2000 DUKE STREET, SUITE 100, ALEXANDRIA, VA, 22314, US

(21) Appl. No.: 12/461,707

(22) Filed: Aug. 21, 2009

(51) Int. Cl. A01K 97/00

(52) U.S. Cl. 43/4; 43/54.1; 43/55

(57) ABSTRACT

The present invention describes a bait rigging holder constructed from only a single block of material such as plastic. The bait holder is provided with a first pair of side members having a trough or slot extending along the entire length of these first pair of side members. A second pair of side members extend from the end of the first pair of side members and are also provided with a slot or trough therethrough. The height of the second pair of side members is less than the height of the first pair of side members. The bait rigging holder is utilized to rig a bait fish, such as a ballyhoo by allowing a fisherman to appropriately attach the bait fish to a hook, such as a circle hook.

### FIELD OF THE INVENTION

The present invention is directed to the field of fishing equipment, more specifically to a device for allowing a fisherman to easily rig bait.

### BACKGROUND OF THE INVENTION

The sport of fishing is a very popular endeavor for a multitude of people. This sport allows the participants to catch fish for their own dietary use. Additionally, this sport is quite relaxing even when the purpose is not to devour the fish but is utilized in a catch and release environment. Finally, this sport allows different individuals to compete in catching various classes of fish.

Most fishermen utilize a baited hook in their endeavors to catch a fish. The bait that is utilized can take many forms. One type of bait that has gained popularity is to use a small fish, such as a ballyhoo which is directly attached to a hook, such as a circle hook. Through the years, many techniques have been developed which would allow a fisherman to bait a hook. Ballyhoo bait are without a doubt the most effective and available baits for trolling and are well suited for use with a circle hook. One method of baiting a hook used with a ballyhoo would be to employ a small wire loop while another method would incorporate a barrel swivel. Although these two types of methods are still in use, many fishermen utilize wax rigging floss to rig their baits. While this might be an easier and faster manner of rigging a ballyhoo, the fisherman must put a tag end of the floss in their mouth to tighten the knot. Since ballyhoo are treated with formaldehyde before packaging, this method could be very unappetizing.

A bait rigging holder described in U.S. Pat. No. 7,207,132, to Parsons, attempts to address this problem of putting the ballyhoo or the wax rigging floss in one's mouth. This bait rigging holder includes a generally rectangular base 20 carrying a longitudinally extending V-shaped trough 22 attached to a pair of front and rear support legs 24, 25 resting upon a base 20. The trough 22 is produced utilizing a front side plate 26 and a rear side plate 28. The trough 22 is provided with a frontally opening slot 30 as well as al transverse slot 32 positioned slightly forward of the support leg 25 and slightly vertically behind the base of the slot 30. The bait rigging holder described in the Parsons' device is relatively difficult to produce and could still afford problems in baiting the fish.

### SUMMARY OF THE INVENTION

The aforementioned deficiencies in the prior art are addressed by the present invention which is utilized to bait ballyhoo for the purpose of attaching a hook, such as a circle hook, to the bait. Although the present invention will be described with respect to rigging ballyhoo as bait fish, it is noted that the present invention is not so limited and could be used to bait other types of fish.

The present invention is produced utilizing only a single piece of material, such as plastic or wood. The bait rigging holder of the present invention can be produced by inserting the solid piece of material into a mold and removing certain pieces of the material to produce the device as shown in the drawings of the present invention. As illustrated in FIGS. 1-4 of the present invention, the bait rigging holder includes a longitudinal base surrounded by two upwardly extending side members. Therefore, a longitudinal trough or slot is produced which would extend from the rear of the holder to a front portion concluding with the ends of the side members. The trough or slot would extend beyond these first two side members and would be defined by two additional side members having a lesser height than the first two side members.

### BRIEF DESCRIPTION OF THE DRAWINGS

The bait rigging holder of the present invention will be described in more detail hereinafter in conjunction with the following drawings wherein:

FIG. 1 is a perspective drawing of the bait rigging holder of the present invention;

FIG. 2 is a top view of the bait rigging holder illustrated in FIG. 1;

FIG. 3 is an end view of the bait rigging holder illustrated in FIG. 1;

FIG. 4 is a bottom view of the bait rigging holder illustrated in FIG. 1; and

FIGS. 5-14 illustrate a method of rigging bait utilizing the bait rigging holder of the present invention.

### DETAILED DESCRIPTION OF THE PRESENT INVENTION

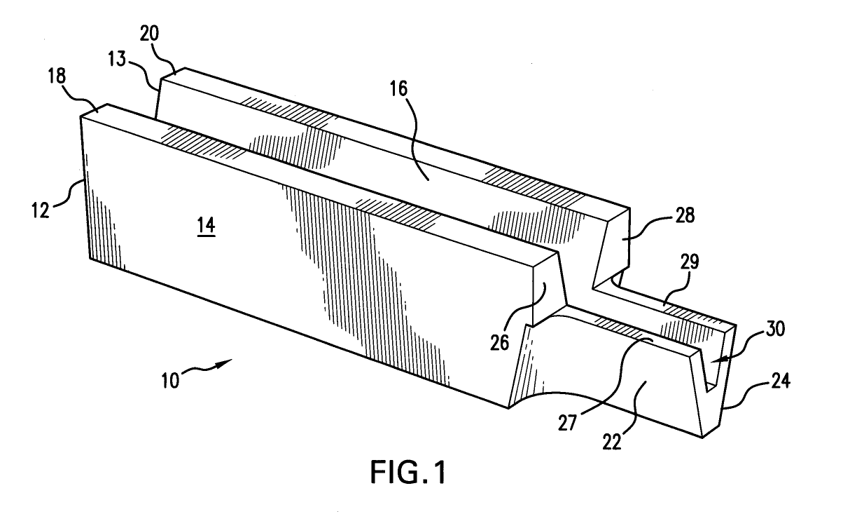

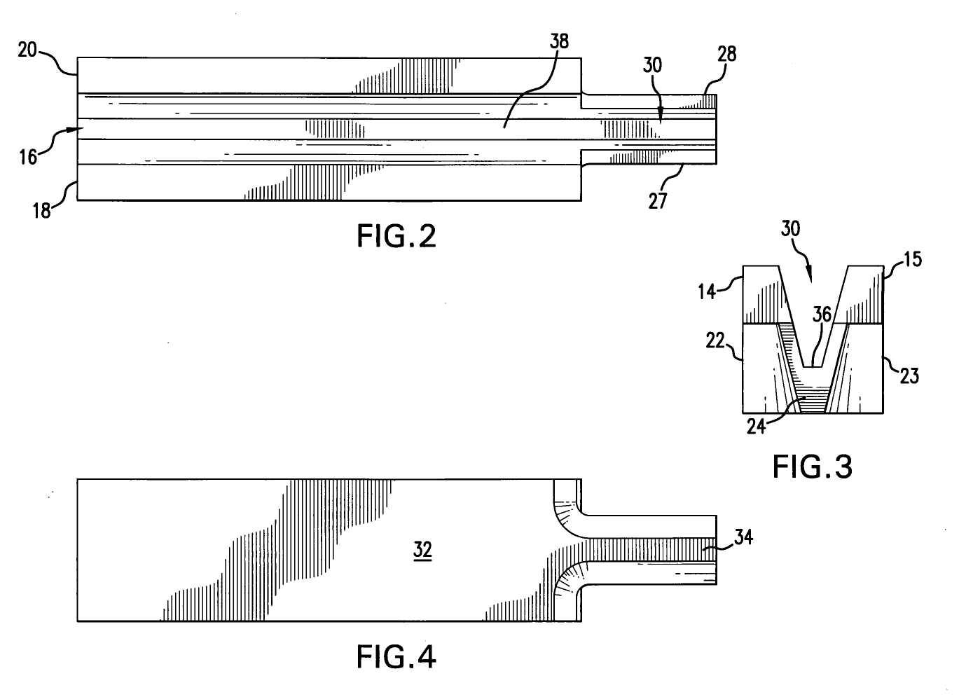

FIGS. 1-4 illustrate the present invention after it has been removed from a mold which would mass produce the present invention, or after the appropriate sections have been cut from a single block of plastic or wood by hand. The resultant bait rigging holder 10 constructed from the single block would include a first side member 14 extending from the end 12 of the bait rigging holder 10 to a front end 26. A top surface 18 of the first side member 14 would also extend from a rear end 12 to the front end 26.

A second side member 15 (see FIG. 3) would extend from a rear portion 13 to a front portion 28. A trough or slot 16 is formed between the side members 14 and 15. As shown in FIG. 1, and depicted by the shapes 26 and 28 of the front portions of the side members 14, 15, the trough 16 is angled so that the distance between the top surface 18 of side member 14 and the top surface 20 of side member 15 is greater than the distance between the inner surfaces of the side members 14 and 15 measured at a base 38 of the trough or slot 16 extending between the inner surfaces of side members 14 and 15. Although the drawings show that the side members 14 and 15 are angled with respect to one another, this need not be the case of the inner surfaces of the side members 14 and 15 could be perpendicular to the base 38 along the entire height of the side member 14 and 15.

The trough or slot 16 extends beyond the ends 26, 28 of the side members 14, 15 to provide a s trough or slot 30 extending to the end of 24 of the base rigging holder 10. The trough or slot 30 having a base 36 is surrounded by side members 22, 23. The height of each of the side members 22, 23 are less than the height of the side members 14 and 15. The side members 22, 23 extend from a base 34 which is continuous with a base 32 from which the side members 14 and 15 extend. The side member 22 would include a top portion 27 extending from the end 26 of the end member 14 to the end 24 of the slot or trough 30. A top portion 29 extending from the end 28 of the side member 15 to the end of the trough or slot 30 at 24 is included on the side member 23.

Similar to the portion provided between the side members 14 and 15, the side portion 22 and 23 of the slot or trough 30 are angled with respect to one another. However, as is also true with respect to a trough or slot portion 16, the side members 22 and 23 need not be angled with respect to one another and could be perpendicular to the floor 36 of the continued trough or slot 30.

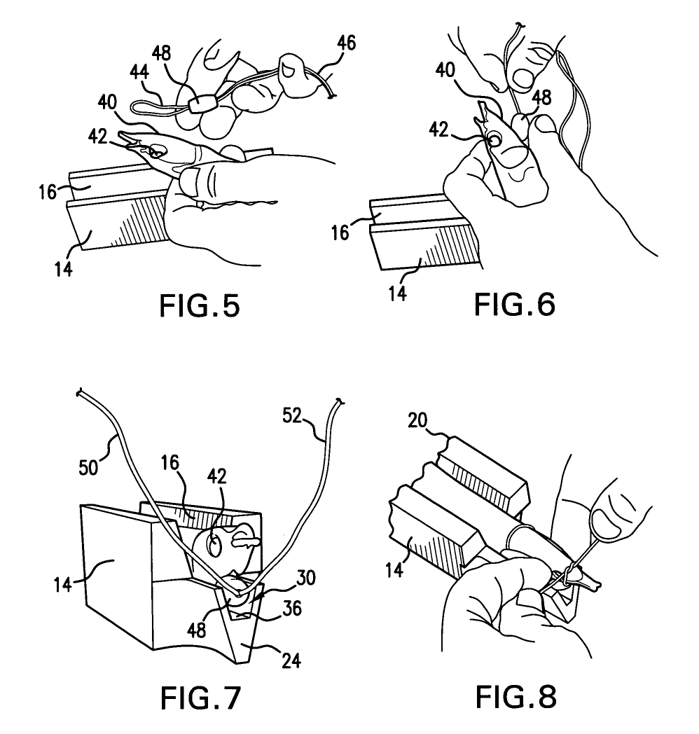

The method of rigging the ballyhoo or other type of bait fish will now be explained with respect to FIGS. 5-14. This method would utilize an appropriate length of rigging floss 46 allowing enough line to adequately bait a fish 40. It has been found that 18 inches of rigging floss would be sufficient. However, a slightly shorter or longer length of rigging floss 46 could be utilized. As shown in FIG. 5, the floss 46 is doubled back on itself and thread through a sinker 48, such as an egg sinker leaving an inch long loop 44 ahead of the sinker 48. The loop 44 is placed over the head of the bait fish 40 and the rigging floss is threaded behind both of the gill plates of the fish 40 as shown in FIG. 6. The rear end of the bait fish 40 is placed within the trough or slot 16 on the base 38 between the side members 14 and 15 of the bait rigging holder. The head portion of the bait fish 40 extends over the trough 30 with the egg sinker resting between the side members 22, 23 of the trough 30 as illustrated in FIG. 7.

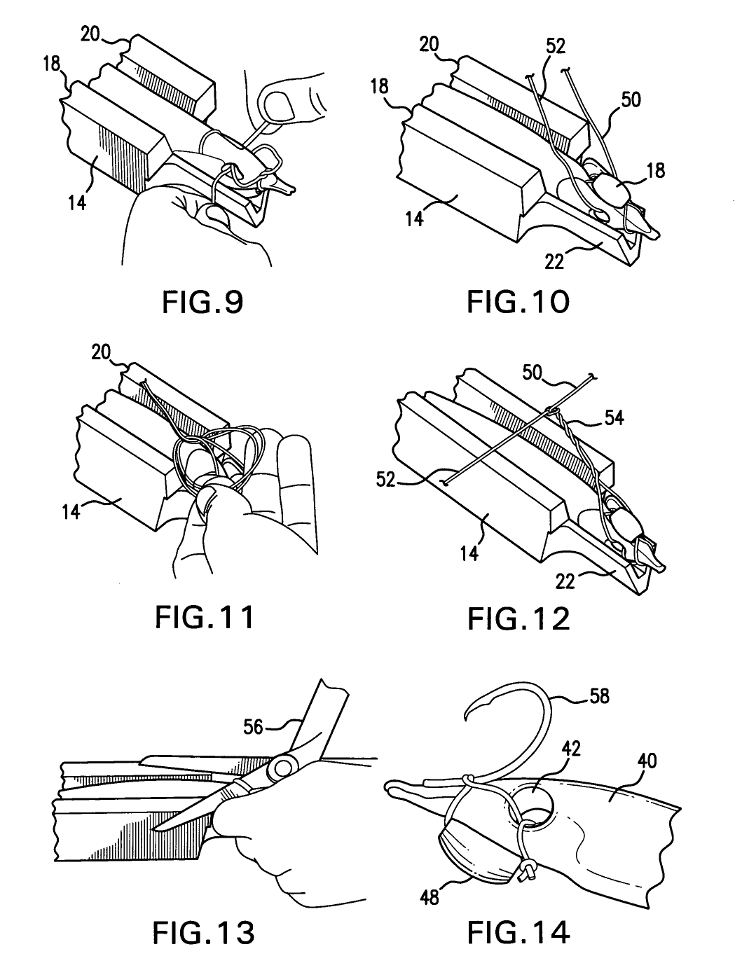

As shown in FIG. 8, an overhand knot is created by holding the bait fish in position and by placing the index fingers in the eye socket 42 of the bait fish while simultaneously pulling on each tag end 50, 52 to tighten the rigging floss around the head of the bait fish 40. The tag end 50 and 52 of the rigging floss is passed through the eye socket 42, one from each side and is generally pulled tight as described in FIG. 9. The bait fish is then removed from the bait rigging holder 10 and turned on its back and then reinserted into the bait rigging holder as shown in FIG. 10 at the same time making a second overhand knot as shown in FIG. 11. Each tag 50 and 52 is pulled in different directions until the formed knot 54 slides down and pulls the gill plates firmly shut, as illustrated in FIG. 12. Both ends of the tag ends 50, 52 are trimmed by a scissor, knife, razor or similar device 56, as shown in FIG. 13.

At this point, a hook, such as a circle hook 58 is placed under the initial overhand knot as shown in FIG. 14 and the bait fish can now be deployed.

The foregoing description of the preferred embodiment of the present invention has been presented for purposes of illustration and description. It is not intended to be exhaustive or to limit the invention to the precise form disclosed, and obviously many modifications and variations are possible in light of the above teaching. The proceeding embodiment was chosen and described as to best explain the principles of the present invention and its practical application to thereby enable others skilled in the art to best utilize invention in the described embodiments, and with various modifications and, and with various modifications as are suited to the particular use contemplated.

What is claimed is:

1. A device for rigging bait, comprising:
a holding device for supporting the bait when the bait is rigged, said holding device comprising a base, a first pair of side members extending for a portion of the length of said base, a second pair of side members extending from the end of said first pair of side members for the remainder of the length of said base, the height of said second pair of side members being less than the height of said first pair of side members, and a slot extending for the entire length of said base, said slot provided between said first and second pair of side members.

2. The device in accordance with claim 1, wherein each of said first pair of side members is angled with respect to one another.

3. The device in accordance with claim 2, wherein each of said second pair of side members is angled with respect to one another.

4. The device in accordance with claim 1, wherein said holding device is constructed from a single block of material.

5. The device in accordance with claim 4, wherein said single block of material is plastic.
